(19) United States
(12) Patent Application Publication
(10) Pub. No.: US 2023/0028136 A1
(43) Pub. Date: Jan. 26, 2023

(54) ADJUSTABLE LIGHT SOURCE

(71) Applicant: Microchip Technology Incorporated, Chandler, AZ (US)

(72) Inventors: Tik Man Lee, Chandler, AZ (US); Adrian Yuk-Kei Wong, Tai Po (HK)

(21) Appl. No.: 17/649,884

(22) Filed: Feb. 3, 2022

Related U.S. Application Data
(60) Provisional application No. 63/203,498, filed on Jul. 26, 2021.

(51) Int. Cl. H05B 45/12; H05B 47/105; H05B 47/19

(52) U.S. Cl. CPC H05B 45/12; H05B 47/105; H05B 47/19

(57) ABSTRACT

Various examples relate to adjustable light sources. An example may include an apparatus including a light source to adjustably emit light toward a region of interest at least partially responsive to a control signal. The apparatus may also include a sensor to generate a signal indicative of an intensity of light sensed by the sensor in the region of interest. The apparatus may also include a wireless-communication equipment to broadcast a value that represents the intensity of light received by the sensor. The wireless-communication equipment may also receive a broadcast of a further value that represents an intensity of light in a further region of interest. The apparatus may also include a processor to adjust the control signal at least partially responsive to the further value. Related devices, systems and methods are also disclosed.

### CROSS-REFERENCE TO RELATED APPLICATIONS

This application claims the benefit of the priority date of U.S. Provisional Patent Application No. 63/203,498, filed Jul. 26, 2021, and titled “Self-Tuning Lighting System,” the disclosure of which is incorporated herein in its entirety by this reference.

### FIELD

This description relates, generally, to an adjustable light source. More specifically, some examples relate to a light source that adjusts light emitted thereby responsive to sensed light, without limitation. Related systems, devices, and methods are also disclosed.

### BACKGROUND

Some environments are illuminated by a number of light sources. For example, a room may be illuminated by four or more light sources at various locations in the ceiling of the room. One or more of the individual light sources may emit light that is different (e.g., in intensity and/or color) from light emitted by the others of the light sources. Different light being emitted by different light sources in the same environment may be less aesthetically pleasing than light that is the same being emitted by all of the light sources of an environment.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a functional block diagram illustrating an example environment in which an apparatus in accordance with various examples of the disclosure may operate.

FIG. 2 is a functional block diagram illustrating an example system in accordance with various examples of the disclosure.

FIG. 3 is a functional block diagram illustrating another example system in accordance with various examples of the disclosure.

FIG. 4 is a flowchart of an example method, in accordance with various examples of the disclosure.

FIGS. 5A-5B is a flowchart of another example method, in accordance with various examples of the disclosure.

FIG. 6 illustrates a block diagram of an example device that may be used to implement various functions, operations, acts, processes, and/or methods, in accordance with one or more examples.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are only examples and should not be construed as the only way to implement the present disclosure unless specified otherwise herein. Additionally, block definitions and partitioning of logic between various blocks is an example of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

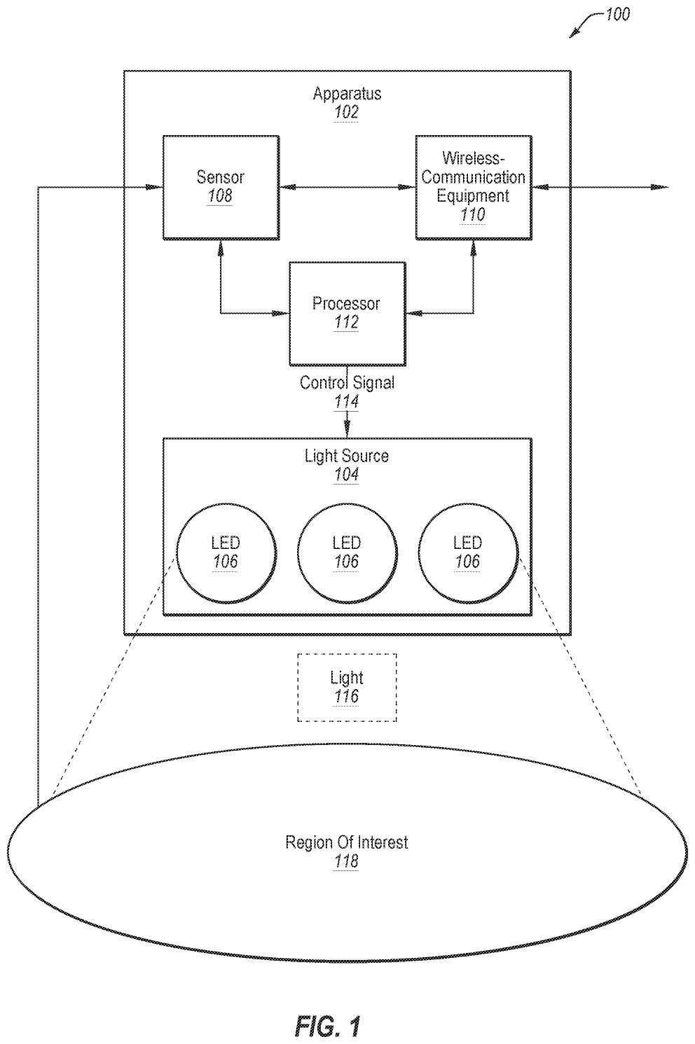

FIG. 1 is a functional block diagram illustrating an example environment 100 in which an apparatus 102 in accordance with various examples of the disclosure may operate. Apparatus 102 may adjustably emit light 116. In some examples, apparatus 102 may adjust its emissions of light 116 for various purposes. Further, in some examples, apparatus 102 may adjust its emissions of light 116 automatically, and/or without external instructions or control. As an example of purposes for which apparatus 102 may adjust its emissions of light 116, in some examples, apparatus 102 may operate in an environment with one or more other apparatuses (not illustrated in FIG. 1) are variously emitting and/or sensing light such that all of the light-emitting apparatuses emit light of a uniform intensity (e.g., lumens, without limitation) and/or color (e.g., hue, shade, or color temperature, without limitation). In such examples, each of the light-emitting apparatuses may emit light as intense as a most-intense capacity of a dimmest light-emitting apparatus of the light-emitting apparatuses. Additionally or alternatively, in such examples each of the light emitting apparatuses may emit light matching a color of all of the other light emitting apparatuses.

Apparatus 102 may include light source 104 which may emit light 116 at least partially responsive to control signal 114. Light source 104 may include one or more light sources. For example, light source 104 may include one or more separate light sources each of which emits light of a different wavelength and/or intensity, without limitation. For example, light source 104 may include three or more light-emitting diodes (LEDs) 106 (collectively referred to herein as “LEDs 106” and/or individually as “LED 106”), e.g., a red LED, a green LED, and blue LED, without limitation.

Sensor 108 may sense light in a region of interest 118. Sensor 108 may measure an intensity and/or color of light in the region of interest. For example, sensor 108 may include multiple sensors to individually sense intensities of light at different wavelengths in the region of interest. For example, sensor 108 may include a charge-coupled device having multiple sensor pixels filtered by respective filters, e.g., red, green, and blue filters. Sensor 108 may generate a signal indicative of one or more intensities of light sensed by the sensor 108. Sensor 108 may provide the signal to either or both of wireless-communication equipment 110 and processor 112.

In the present disclosure, the term “color” and “color of light” may refer to two or more intensities in two or more wavelengths. For example, a color of light may be measured by a sensor 108. As another example, light of a color may be emitted by a light source 104. In both examples, the color may include a first intensity of light in a first wavelength (e.g., a red wavelength e.g., about 652 nanometers (nm)), a second intensity in a second wavelength (e.g., a green wavelength e.g., about 520 nm), and a third intensity in a third wavelength (e.g., a blue wavelength e.g., about 445 nm).

Sensor 108 may sense light 116 in region of interest 118 by being in, or being arranged to capture light from, region of interest 118. For example, sensor 108 may sense light 116 in region of interest 118 by being pointed toward region of interest 118. In these or other examples, region of interest 118 may encompass apparatus 102 including sensor 108.

In some examples, apparatus 102 may include sensor 108, for example, sensor 108 may be physically coupled to light source 104. In other examples, sensor 108 may be external to apparatus 102 but may be associated with apparatus 102. For example, sensor 108 may be communicatively coupled to apparatus 102 and apparatus 102 may determine that sensor 108 is associated with apparatus 102. For example, apparatus 102 may determine that sensor 108 is sensing light 116 emitted by apparatus 102, e.g., by determining that sensor 108 is proximate to apparatus 102 and/or by determining that light 116 emitted by light source 104 toward region of interest 118 is sensed by sensor 108 in region of interest 118. In some examples, apparatus 102 may be associated with region of interest 118 (e.g., by emitting light toward region of interest 118), sensor 108 may be associated with region of interest 118 by sensing light in region of interest 118, and apparatus 102 may be associated with sensor 108 by virtue of both apparatus 102 and sensor 108 being associated with region of interest 118.

Wireless-communication equipment 110 may broadcast and receive wireless signals. In particular, wireless-communication equipment 110 may broadcast a signal indicative of one or more values that represents one or more respective intensities of light received by sensor 108. For example, after receiving the signal indicative of one or more intensities of light sensed by sensor 108 (e.g., from sensor 108 or from processor 112) and, in some cases, after receiving a signal (e.g., from processor 112) instructing wireless-communication equipment 110 to broadcast the one or more values, wireless-communication equipment 110 may broadcast the signal indicative of the one or more values wirelessly.

Further, wireless-communication equipment 110 may receive a signal indicative of a further one or more values that represents respective one or more intensities of light in a further region of interest. For example, another apparatus, that is the same as or substantially similar to apparatus 102, may sense intensities of light in the further region of interest and broadcast a signal indicative of the further one or more values representative of the respective one or more intensities of light in the further region of interest. Wireless-communication equipment 110 may provide the received signal and/or the received further value to processor 112.

Wireless-communication equipment 110 may be, or may include, any suitable wireless communication equipment including, e.g., a transceiver and/or antenna. Wireless-communication equipment 110 may broadcast and receive wireless signals according to any suitable protocol including, e.g., Institute of Electrical and Electronics Engineers (IEEE) 802.11 and Bluetooth™ without limitation.

Processor 112 may adjust the control signal 114 (responsive to which light source 104 emits light 116) at least partially responsive to the further one or more values (received at wireless-communication equipment 110 and representative of the respective intensities of light in the further region of interest). Processor 112 may adjust control signal 114 such that the light 116 emitted by light source 104 matches the intensity and/or color of light of the further region of interest (e.g., as indicated by the further one or more values). Processor 112 may adjust control signal 114 independent of the measurements of sensor 108 (e.g., independent of light measured by sensor 108 of region of interest 118).

In examples in which light source 104 includes two or more light sources (e.g., red, green, and blue LEDs without limitation), control signal 114 may include two or more corresponding channels. For example, processor 112 may adjust three channels of control signal 114 (e.g., a channel for red, a channel for green and a channel for blue) such that light 116 emitted by light source 104 matches the color of light of the further region of interest. In other words, processor 112 may adjust a red channel of control signal 114 such that light emitted by a red LED of light source 104 matches an intensity of red light measured in the further region of interest, light emitted by a green LED of light source 104 matches an intensity of green light measured in the further region of interest, and light emitted by a blue LED of light source 104 matches an intensity of blue light measured in the further region of interest.

Additionally or alternatively, processor 112 may control operations of apparatus 102 more generally. For example, processor 112 may instruct wireless-communication equipment 110 regarding broadcasting of signals (including, e.g., signals indicative of the one or more intensities of light sensed by sensor 108).

In some examples, processor 112 may determine whether light source 104 is functioning properly. For example, processor 112 may determine whether light source 104 has failed. For example, processor 112 may determine whether light source 104 has failed based on a signal from sensor 108 indicating a difference between an intensity of light sensed in region of interest 118 and an instruction of control signal 114. As another example, processor 112 may determine light source 104 has failed based on a signal from light source 104, e.g., current flowing into or not flowing into light source 104, without limitation. In any case, processor 112 may instruct wireless-communication equipment 110 to broadcast an error message in response to processor 112 determining that light source 104 has failed.

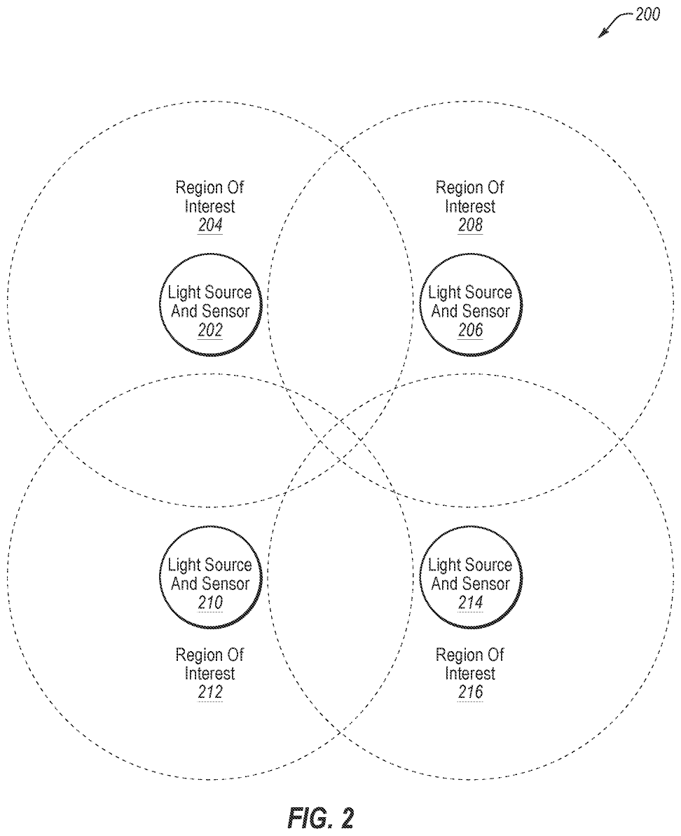

FIG. 2 is a functional block diagram illustrating an example system 200 in accordance with various examples of the disclosure. System 200 may include multiple light source and sensors. Each of the light source and sensors may sense one or more intensities of light in a respective region of interest and broadcast a signal indicative of one or more values representative of the sensed respective intensities of light. Further, each of the light source and sensors may adjust light being emitted thereby responsive to received one or more values of received broadcasts.

System 200 includes four light source and sensors (i.e., light source and sensor 202, light source and sensor 206, light source and sensor 210, and light source and sensor 214) for descriptive purposes. In other examples, systems may include any number (two or higher) of light source and sensors.

Each of light source and sensor 202, light source and sensor 206, light source and sensor 210, and light source and sensor 214 (in other words, each of the light source and sensors of system 200) may be an example of apparatus 102 of FIG. 1. For example, each of light source and sensor 202, light source and sensor 206, light source and sensor 210, and light source and sensor 214 may include a light source (which may be the same as or substantially similar to light source 104 of FIG. 1) and a sensor (which may be the same as or substantially similar to sensor 108 of FIG. 1). Further, each of light source and sensor 202, light source and sensor 206, light source and sensor 210, and light source and sensor 214 may include a wireless-communication equipment (which may be the same as or substantially similar to wireless-communication equipment 110 of FIG. 1) and a processor (which may be the same as or substantially similar to processor 112 of FIG. 1).

Further, each of light source and sensor 202, light source and sensor 206, light source and sensor 210, and light source and sensor 214 may operate in the same way, or substantially the same way, as apparatus 102 of FIG. 1. Further, each of light source and sensor 202, light source and sensor 206, light source and sensor 210, and light source and sensor 214 may operate according to the same instructions (as each of the others) to adjust the respective light being emitted thereby.

For example, each of light source and sensor 202, light source and sensor 206, light source and sensor 210, and light source and sensor 214 may sense a respective intensity (and/or color) of light at a respective region of interest. For example, light source and sensor 202 may sense an intensity (and/or color) of light at region of interest 204, light source and sensor 206 may sense an intensity (and/or color) of light at region of interest 208, light source and sensor 210 may sense an intensity (and/or color) of light at region of interest 212, and light source and sensor 214 may sense an intensity (and/or color) of light at region of interest 216. Further, each of light source and sensor 202, light source and sensor 206, light source and sensor 210, and light source and sensor 214 may broadcast a respective signal indicative of a respective value representative of the sensed intensity (and/or color) of light at the respective region of interest. For example, light source and sensor 202 may broadcast a signal indicative of one or more values representative of an intensity (and/or color) of light sensed at region of interest 204, light source and sensor 206 may broadcast a signal indicative of one or more values representative of an intensity (and/or color) of light sensed at region of interest 208, light source and sensor 210 may broadcast a signal indicative of one or more values representative of an intensity (and/or color) of light sensed at region of interest 212, and light source and sensor 214 may broadcast a signal indicative of one or more values representative of an intensity (and/or color) of light sensed at region of interest 216.

Further still, each light source and sensor 202, light source and sensor 206, light source and sensor 210, and light source and sensor 214 may adjust respective light being emitted thereby at least partially responsive to one or more received broadcasts including respective one or more values representative of one or more respective intensities of light in one or more respective other regions. For example, light source and sensor 202 (or a processor of light source and sensor 202) may adjust light being emitted by light source and sensor 202 responsive to one or more values indicative intensities of light at each of one or more of region of interest 208, region of interest 212, and region of interest 216 as received in broadcasts from one or more of light source and sensor 206, light source and sensor 210, and light source and sensor 214, respectively.

In some examples, each of light source and sensor 202, light source and sensor 206, light source and sensor 210, and light source and sensor 214 may select which values to base its adjustments on from among two or more received values of two or more received signals. In some examples, each of light source and sensor 202, light source and sensor 206, light source and sensor 210, and light source and sensor 214 may select which values to base its adjustments on based on a relative signal strength of the two or more broadcasts as received at the respective light source and sensor making the adjustment. The relative signal strength may be a proxy for relative distances between the light source and sensor making the adjustment and the other light source and sensors. As an example, the distance between a first light source and sensor and a second light source and sensor may be a consideration when determining how relevant light sensed at the second light source and sensor is to the first light source and sensor in determining to adjust light at the first light source and sensor. For example, the first light source and sensor may give more weight to light sensed close to the first light source and sensor than to light sensed at a location distant from the first light source and sensor.

For example, light source and sensor 202 may receive a signal broadcast from each of light source and sensor 206, light source and sensor 210, and light source and sensor 214. Light source and sensor 202 (or a wireless-communication equipment of light source and sensor 202) may measure a signal strength of each of the received signals. Based on the measured signal strengths, light source and sensor 202 (or a processor of light source and sensor 202) may determine to adjust light emitted by light source and sensor 202 based on signals broadcast from light source and sensor 206 and light source and sensor 210 based on the signal strength of the signals from light source and sensor 206 and light source and sensor 210 being greater than a signal strength of a signal received from light source and sensor 214. For example, light source and sensor 202 may select a number of received signals with the highest signal strength (e.g., the two received signals with the highest signal strength, without limitation) and adjust light emitted by light source and sensor 202 based on one or more values representative of the intensities of light of such signals. As another example, light source and sensor 202 may select all values of all signals with a signal strength that is higher than a threshold and adjust light emitted by light source and sensor 202 based on the values representative of the intensities of light of such signals.

Additionally or alternatively, each of light source and sensor 202, light source and sensor 206, light source and sensor 210, and light source and sensor 214 may adjust light being emitted thereby based on an average of two or more values representative of light measured at two or more other regions of interest. For example, light source and sensor 202 may adjust light emission at light source and sensor 202 based on an average of values indicative of intensities of light of other regions of interest, e.g., as received in signals broadcast from light source and sensors of the other regions of interest. For example, light source and sensor 202 may adjust light being emitted by light source and sensor 202 to match an average of light measured at region of interest 208 and region of interest 212, e.g., as measured and reported by light source and sensor 206 and light source and sensor 210 respectively. Additionally or alternatively, each of light source and sensor 202, light source and sensor 206, light source and sensor 210, and light source and sensor 214 may adjust light being emitted thereby based on a most intense, or a least intense, light measured at the two or more other regions of interest.

In some examples, each of light source and sensor 202, light source and sensor 206, light source and sensor 210, and light source and sensor 214 may adjust light emitted thereby independent of light measured in a region of interest of the respective light source and sensor and/or light measured by the respective light source and sensor. For example, light source and sensor 202 may adjust light being output by light source and sensor 202 independent of an intensity (and/or color) of light measured at region of interest 204 and/or, independent of the intensity (and/or color) of light measured by light source and sensor 202. In other words, light source and sensor 202 may adjust light being emitted at light source and sensor 202 based on intensities (and/or colors) of light measured at region of interest 208, region of interest 212, and/or region of interest 216 and not based on an intensity (and/or color) of light measured at region of interest 204 and/or not based on the intensity (and/or color) of light measured by light source and sensor 202.

In some examples, each of light source and sensor 202, light source and sensor 206, light source and sensor 210, and light source and sensor 214 may adjust light emitted thereby to match an intensity (and/or color) of light measured at one or more other regions of interest. For example, light source and sensor 202 may adjust light being emitted thereby to match an intensity (and/or color) of light measured at region of interest 208 and/or to match an average of the intensity (and/or color) of light measured at region of interest 208 and region of interest 212.

Not all of light source and sensor 202, light source and sensor 206, light source and sensor 210, and light source and sensor 214 may be equally capable of emitting light. For example, one or more of light source and sensor 202, light source and sensor 206, light source and sensor 210, and light source and sensor 214 may be older, degraded, have been produced by a different manufacturer, and/or have been produced with a different quality and thus may not be equally able to emit light as the others. For example, light source and sensor 202 may be able to emit light of a greater intensity than the most-intense light that light source and sensor 206 is able to emit.

A net effect of each of the light source and sensors attempting to match an intensity (and/or color) of light measured in other regions of interest may be that all of the one or more light source and sensors emits light of a uniform intensity and/or a uniform color, whether or not the light source and sensors are all identical or equally capable of emitting light. For example, if a first light source is attempting to match the intensity of a second light source and the second light source is attempting to match the intensity of the first light source, the dimmer of the two light sources (e.g., the first light source) may increase the intensity of light emitted thereby until it reaches its most intense capacity while attempting to match the intensity of the brighter light source (e.g., the second light source). Additionally, the second light source may decrease the intensity of light emitted thereby to match the first light source. The net result may be that both the first light source and the second light source emit light matching the capacity of the first light source. Another net effect of all of the light source and sensors attempting to match an intensity (and/or color) of light measured in other regions of interest may be that the environment including the light source and sensors may be uniformly illuminated by the light source and sensors, whether or not the light source and sensors are all identical or equally capable of emitting light. For example, by matching emitted light to light sensed in other regions of interest, all of the light source and sensors may settle to emit light that is within the capability of all of the light source and sensors.

In some examples, as each of the light sources and sensors adjust light emitted thereby to match light sensed by at least some of the others, one or more of the light source and sensors may adjust light emitted thereby to be more intense than light measured by others of the light source and sensors (at least for a time). For example, a light source and sensor may increase an intensity of light emitted thereby, then the light source and sensor and/or others of the light source and sensors will sense the more-intense light, and broadcast values indicating the more-intense light. Thereafter, others of the light source and sensors (having received the broadcast values) may adjust light being emitted thereby to be more intense in response.

The light source and sensors may emit more-intense light for a limited time such that by default (i.e., outside the limited time), all the light source and sensors match the light sensed at the other regions of interest. If, during the limited time the others of the light source and sensors adjust to match the more-intense light, then, following the limited duration, the light-source and sensor that emitted more-intense light during the limited duration will sense the more-intense light of the others of the light source and sensors and will match the more-intense light. In such cases, light emitted by all of the light source and sensors will have become more intense. However, if during the limited time, others of the light source and sensors were not capable of emitting the more-intense light, the light source and sensor that emitted the more-intense light will return to emitting light to match the others of the light source and sensors.

Because each of light source and sensor 202, light source and sensor 206, light source and sensor 210, and light source and sensor 214 emits light responsive to (e.g., attempting to match, without limitation) light sensed at one or more regions of interest proximate to its own region of interest, the net effect of one light source and sensor increasing intensity of emitted light (for a limited time) may be that all of the light source and sensors emits light as intense as a most-intense capacity of a dimmest light source and sensor of system 200.

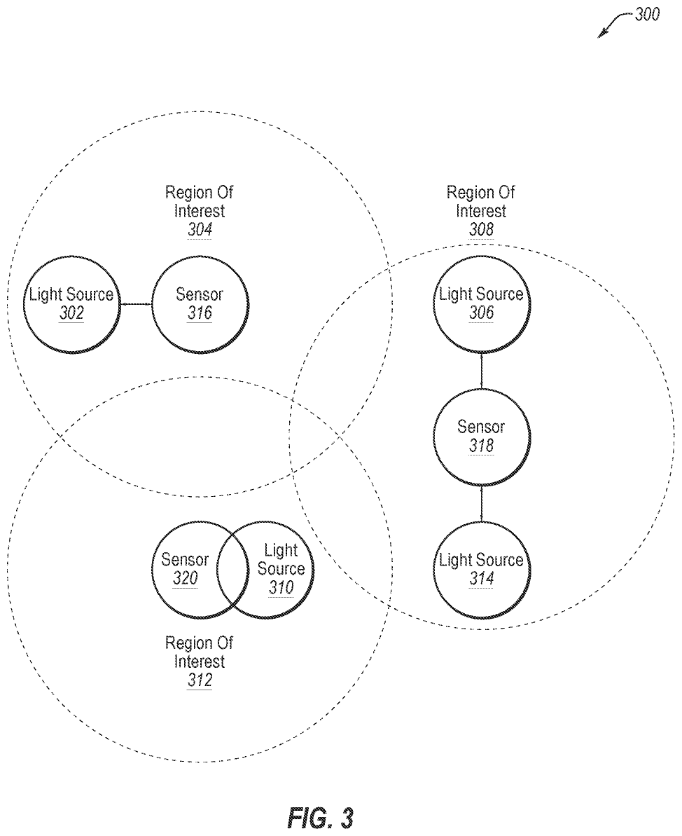

FIG. 3 is a functional block diagram illustrating another example system 300 in accordance with various examples of the disclosure. System 300 may be similar to system 200 of FIG. 2 in that system 300 may include many of the same elements as system 200, system 300 may include many elements that are substantially similar to the elements of system 200, and/or system 300 may perform many or all of the same operations as system 200. For example, system 300 includes light sources and sensors. Each light source may be associated with a region of interest and/or a sensor in a region of interest. Each of the sensors may sense one or more intensities of light in a respective region of interest and broadcast a signal indicative of one or more values representative of the sensed one or more intensities of light. Further, each of the light sources may adjust light being emitted thereby responsive to received one or more values of respective received broadcasts, the one or more values representative of one or more intensities of light in other respective regions of interest.

System 300 includes four light sources (i.e., light source 302, light source 306, light source 310, and light source 314) for descriptive purposes. In other examples, systems may include any number (two or higher) of light sources. System 300 includes three sensors (i.e., sensor 316, sensor 318, and sensor 320) for descriptive purposes. In other examples, systems may include any number (two or higher) of sensors.

A difference between system 200 and system 300 is that in system 200, the light sources are collocated with sensors as light source and sensors whereas in system 300 the light sources are physically separate from the sensors. However, like system 200, each of the light sources of system 300 include a light source (e.g., the same as or substantially similar to light source 104 of FIG. 1), a wireless-communication equipment (e.g., the same as or substantially similar to wireless-communication equipment 110 of FIG. 1), and a processor (e.g., the same as or substantially similar to processor 112 of FIG. 1)

Further, each of the light sources of system 300 is associated with a sensor (e.g., the same as or substantially similar to sensor 108 of FIG. 1). For example, light source 302 is associated with sensor 316, light source 306 is associated with sensor 318, light source 310 is associated with sensor 320 and light source 314 is associated with sensor 318. The association between light sources and sensors may be based on a communicative coupling between the light sources and the sensors. The communicative coupling may be wired or wireless. Additionally or alternatively, the association between light sources and sensors may be based on physical proximity, e.g., based on a common association with a region of interest.

For example, light source 310 may be associated with sensor 320 based on light source 310 touching, having a wired or wireless connection with, or being included in a common package with sensor 320. Further, light source 310 may be associated with sensor 320 based on light source 310 emitting light toward region of interest 312 and sensor 320 sensing light in region of interest 312. Likewise, light source 302 may be associated with sensor 316 based on light source 302 having a wired or wireless connection to sensor 316, based on light source 302 being close to sensor 316, and/or based on light source 302 emitting light toward region of interest 304 and sensor 316 sensing light in sensor 316. Both light source 306 and light source 314 may be associated with sensor 318 based on both light source 306 and light source 314 having a wired (or wireless) connection to sensor 318, based on light source 306 and light source 314 being close to sensor 318 (or, sensor 318 being closer to light source 306 and light source 314 than any other sensor), and/or based on light source 306 and light source 314 emitting light toward region of interest 308 and sensor 318 sensing light in region of interest 308.

System 300 may perform many or all of the same operations described with regard to system 200.

For example, each of sensor 316, sensor 318, and sensor 320 may sense a respective intensity (and/or color) of light at a respective region of interest. Further, a light source (including a wireless-communication equipment) associated with each of sensor 316, sensor 318, and sensor 320 may broadcast a respective signal indicative of respective one or more values representative of the sensed intensity (and/or color) of light at the respective region of interest. For example, light source 302 may broadcast the signal indicative of the one or more values representative of the sensed intensity (and/or color) of light at region of interest 304, light source 306 (and/or light source 314) may broadcast the signal indicative of the one or more values representative of the sensed intensity (and/or color) of light at region of interest 308, and light source 310 may broadcast the signal indicative of the one or more values representative of the sensed intensity (and/or color) of light at region of interest 312. Additionally or alternatively, in some examples, each of sensor 316, sensor 318, and sensor 320 may broadcast the respective signal indicative of the respective one or more values representative of the sensed intensity (and/or color) of light at the respective region of interest. In such an embodiment, each of sensor 316, sensor 318, and sensor 320 may be provided with a respective wireless communication equipment. In one example, the associated light source may not be provided with the respective wireless communication equipment, and in another example, both the sensor and associated light source are provided with a respective wireless communication equipment.

Further, each light source 302, light source 306, light source 310, and light source 314 may adjust respective light being emitted thereby at least partially responsive to one or more received signals including respective one or more values representative of one or more respective intensities (and/or colors) of light in one or more respective other regions. For example, light source 302 may adjust light being emitted by light source 302 responsive to one or more values indicative intensities (and/or colors) of light at one or more of region of interest 308 and region of interest 312 as received in broadcasts from one or more of light source 310 and light source 306 or light source 314 respectively.

In some examples, each of light source 302, light source 306, light source 310, and light source 314, may select which values to base its adjustments on from among two or more received values of two or more received broadcasts. In some examples, each of light source 302, light source 306, light source 310, and light source 314 may select which values to base its adjustments on based on a relative signal strength of the two or more broadcasts as received at the respective light source making the adjustment. Additionally or alternatively, each of light source 302, light source 306, light source 310, and light source 314 may adjust light being emitted thereby based on an average of two or more values representative of light measured at two or more other regions of interest.

In some examples, each of light source 302, light source 306, light source 310, and light source 314 may adjust light emitted thereby independent of light measured in a region of interest of the respective light source and sensor. For example, light source 306 and light source 314 may adjust light being output by light source 306 and light source 314 respectively independent of an intensity (and/or color) of light measured at region of interest 308, i.e., independent of the intensity (and/or color) of light measured by sensor 318, i.e., the sensor with which light source 306 and light source 314 are associated. In other words, light source 306 and light source 314 may adjust light being emitted by light source 306 and light source 314 respectively based on intensities (and/or colors) of light measured at region of interest 304 and region of interest 312 and not based on an intensity (and/or color) of light measured at region of interest 308, i.e., not based on the intensity (and/or color) of light measured by sensor 318.

In some examples, each of light source 302, light source 306, light source 310, and light source 314 may adjust light emitted thereby to match an intensity (and/or color) of light measured at one or more other regions of interest. In some examples, as each of light source 302, light source 306, light source 310, and light source 314 adjust light to match light sensed by each of the others, one or more of the light sources may adjust light emitted thereby to be more intense than light measured by others of the light sources (at least for a time).

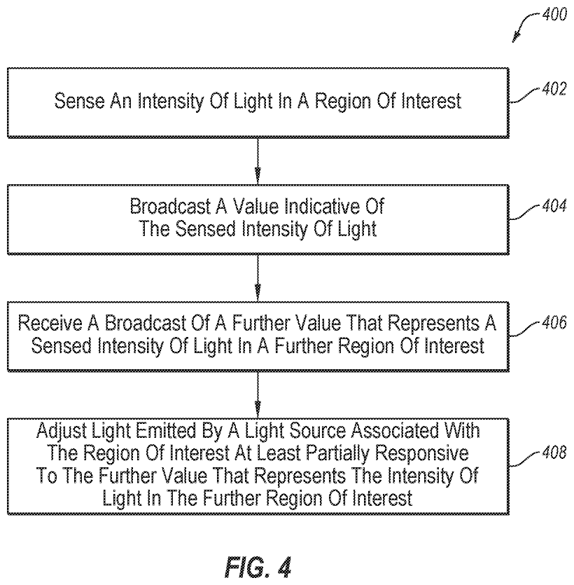

FIG. 4 is a flowchart of an example method 400, in accordance with various examples of the disclosure. At least a portion of method 400 may be performed, in some examples, by a device or system, such as apparatus 102 of FIG. 1, system 200 of FIG. 2, light source and sensor 202, of FIG. 2, light source and sensor 206 of FIG. 2, light source and sensor 210 of FIG. 2, light source and sensor 214, of FIG. 2, system 300 of FIG. 3, light source 302 of FIG. 3 and sensor 316 of FIG. 3, light source 306 of FIG. 3 and sensor 318 of FIG. 3, light source 310 of FIG. 3 and sensor 320 of FIG. 3, light source 314 of FIG. 3 and sensor 318 of FIG. 3, or another device or system. Although illustrated as discrete blocks, various blocks may be divided into additional blocks, combined into fewer blocks, or eliminated, depending on the desired implementation.

In operation 402 an intensity (and/or color) of light in a region of interest may be sensed. For example, sensor 108 of FIG. 1 may sense light 116 of FIG. 1 in region of interest 118 of FIG. 1. As another example, a sensor of light source and sensor 202 of FIG. 2 may sense an intensity (and/or color) of light in region of interest 204 of FIG. 2. As another example, sensor 316 of FIG. 3 may sense an intensity (and/or color) of light in region of interest 304 of FIG. 3.

In operation 404, one or more values indicative of the sensed intensity (and/or color) of light may be broadcast. For example, apparatus 102 may broadcast (e.g., using wireless-communication equipment 110 of FIG. 1) one or more values indicative of the sensed intensity (and/or color) of light. As another example, light source and sensor 202 may broadcast one or more values indicative of the sensed intensity (and/or color) of light. As another example, light source 302 may broadcast one or more values indicative of the sensed intensity (and/or color) of light (i.e., the intensity (and/or color) of light sensed by sensor 316).

In operation 406, a broadcast signal may be received, the broadcast signal may be indicative of further one or more values that represents a sensed intensity (and/or color) of light in a further region of interest. For example, apparatus 102 may receive a broadcast signal indicative of further one or more values representative of a sensed intensity (and/or color) of light in a further region of interest. As another example, light source and sensor 202 may receive a signal broadcast by light source and sensor 206 indicative of one or more values representative of a sensed intensity (and/or color) of light in region of interest 208. As another example, light source 302 may receive a signal broadcast by light source 306 indicative of a value representative of a sensed intensity (and/or color) of light in region of interest 308.

In operation 408, light emitted by a light source may be adjusted. The light source may be associated with the region of interest. The adjustment may be made at least partially responsive to the further one or more values that represent the intensity (and/or color) of light in the further region of interest. For example, apparatus 102 (which may be associated with region of interest 118) may adjust light 116 responsive to the further one or more values. As another example, light source and sensor 202 (which may be associated with region of interest 204) may adjust light emitted by light source and sensor 202 responsive to the one or more values representative of the intensity (and/or color) of light of region of interest 208. As another example, light source 302 (which may be associated with region of interest 304) may adjust light emitted by light source 302 responsive to the one or more values representative of the intensity (and/or color) of light of region of interest 308.

Modifications, additions, or omissions may be made to method 400 without departing from the scope of the present disclosure. For example, the operations of method 400 may be implemented in differing order. Furthermore, the outlined operations and actions are only provided as examples, and some of the operations and actions may be optional, combined into fewer operations and actions, or expanded into additional operations and actions without detracting from the essence of the disclosed example.

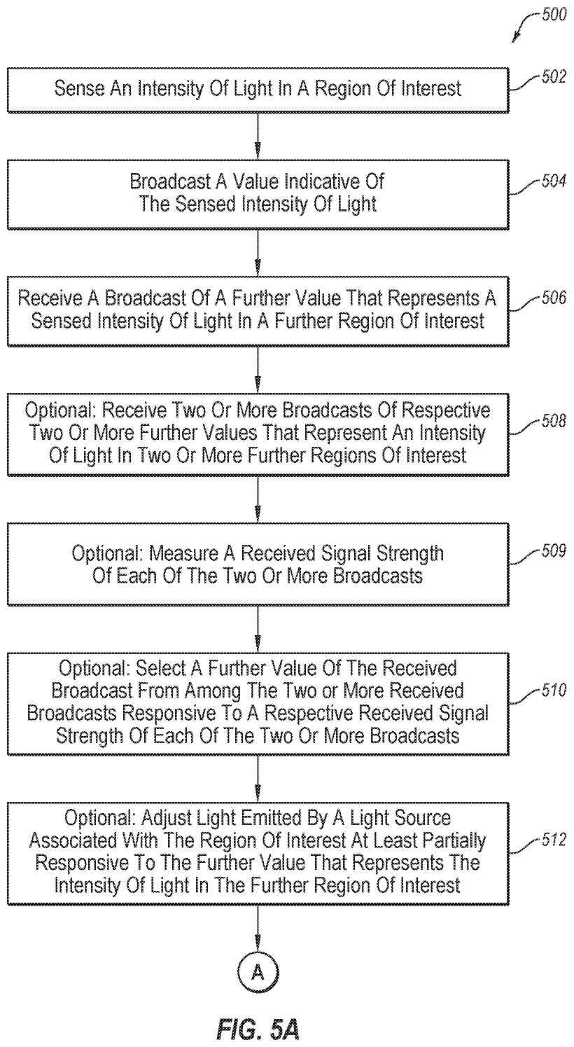

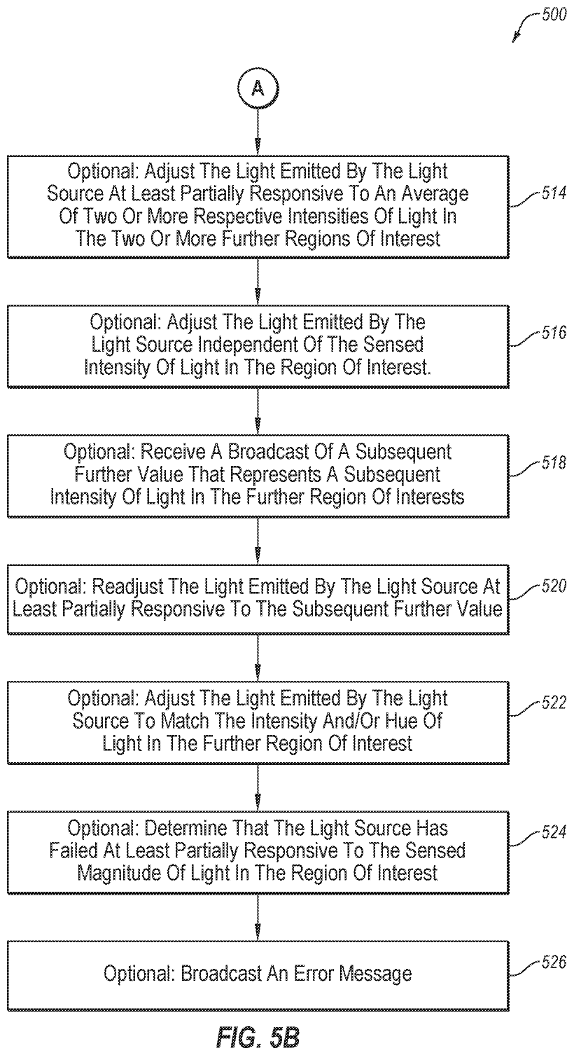

FIGS. 5A-5B together represent a flowchart of another example method 500, in accordance with various examples of the disclosure. At least a portion of method 500 may be performed, in some examples, by a device or system, such as apparatus 102 of FIG. 1, system 200 of FIG. 2, light source and sensor 202, of FIG. 2, light source and sensor 206 of FIG. 2, light source and sensor 210 of FIG. 2, light source and sensor 214, of FIG. 2, system 300 of FIG. 3, light source 302 of FIG. 3 and sensor 316 of FIG. 3, light source 306 of FIG. 3 and sensor 318 of FIG. 3, light source 310 of FIG. 3 and sensor 320 of FIG. 3, light source 314 of FIG. 3 and sensor 318 of FIG. 3, or another device or system. Although illustrated as discrete blocks, various blocks may be divided into additional blocks, combined into fewer blocks, or eliminated, depending on the desired implementation.

Operation 502 may be the same as or substantially similar to operation 402 of FIG. 4. Operation 504 may be the same as or substantially similar to operation 404 of FIG. 4. Operation 506 may be the same as or substantially similar to operation 406 of FIG. 4.

In operation 508, which is optional, two or more broadcasts of respective two or more further values that represent an intensity (and/or color) of light in two or more further region of interest may be received. The two or more broadcasts of operation 508 may include the broadcast received at operation 506. For example, light source and sensor 202 of FIG. 2 may receive a signal broadcast by light source and sensor 206 of FIG. 2 indicative of one or more values representative of a sensed intensity (and/or color) of light in region of interest 208 and a signal broadcast by light source and sensor 210 indicative of one or more values representative of a sensed of FIG. 2 intensity (and/or color) of light in region of interest 212 of FIG. 2. As another example, light source 302 of FIG. 3 may receive a signal broadcast by light source 306 of FIG. 3 indicative of one or more values representative of a sensed intensity (and/or color) of light in region of interest 308 of FIG. 3 and a signal broadcast by light source 310 of FIG. 3 indicative of one or more values representative of a sensed intensity (and/or color) of light in region of interest 312 of FIG. 3.

In operation 509, which is optional, a received signal strength of each of the two or more broadcasts may be measured. The two or more broadcasts may include the broadcast received at operation 506. For example, wireless-communication equipment 110 of FIG. 1 may measure strengths of the received signals.

In operation 510, which is optional, one or more further values of the received broadcast may be selected from among the two or more received broadcasts responsive to a respective received signal strength of each of the two or more broadcasts. For example, light source and sensor 202 may select, from the two or more broadcasts of operation 508, one or more further values of the broadcast from light source and sensor 206 responsive to the broadcast signal from light source and sensor 206 having a higher signal strength than a signal strength of the broadcast signal of light source and sensor 210. As another example, light source 302 may select one or more further values of the broadcast from light source 310 responsive to the broadcast signal from light source 310 having a higher signal strength than a signal strength of the broadcast signal of light source 306.

Operation 512 may be the same as or substantially similar to operation 408 of FIG. 4. However, in method 500, operation 512 may be optional.

In operation 514, which is optional, light emitted by the light source may be adjusted at least partially responsive to an average of two or more respective intensities (and/or colors) of light in the two or more further regions. For example, light source and sensor 202 may adjust light emitted thereby responsive to an average of the intensities (and/or colors) of light at region of interest 208 and region of interest 212 (e.g., as represented by the one or more values of signals broadcast by light source and sensor 206 and light source and sensor 210). As another example, light source 302 may adjust light emitted thereby responsive to an average of the intensities (and/or colors) of light at region of interest 308 and region of interest 312 (e.g., as represented by one or more values of each of the signals broadcast by light source 306 and light source 310). In operation 514, one or more intensities of light emitted by the light source may be adjusted based on an average of one or more intensities from each of the respective further regions of interest. For example, an intensity of red light emitted by the light source (e.g., by a red LED) may be adjusted based on an average of intensities of red light sensed in the further regions of interest. Further an intensity of green light emitted by the light source (e.g., by a green LED) may be adjusted and based on an average of intensities of green light sensed in the further regions of interest. Further, an intensity of blue light emitted by the light source (e.g., by a blue LED) may be adjusted based on an average of intensities of blue light sensed in the further regions of interest.

In operation 516, which is optional, light emitted by the light source may be adjusted independent of the sensed intensity of light in the region of interest. For example, light source and sensor 202 may adjust light emitted thereby independent of the intensity of light sensed at region of interest 204. As another example, sensor 320 may adjust light emitted thereby independent of the intensity of light sensed at region of interest 304.

In operation 518, which is optional, a broadcast signal indicative of a subsequent further one or more values that represents a subsequent intensity (and/or color) of light in the further region of interest may be received. For example, light source and sensor 202 may receive a subsequent signal broadcast by light source and sensor 206. As another example, light source 302 may receive a subsequent signal broadcast by light source 306.

In operation 520, which is optional, the light emitted by the light source may be readjusted based at least partially responsive to the subsequent further one or more values. For example, light source and sensor 202 may readjust light being emitted thereby responsive to the subsequent signal broadcast by light source and sensor 206. As another example, light source 302 may readjust light being emitted thereby responsive to the subsequent signal broadcast by light source 306.

In operation 522, which is optional, light emitted by the light source may be adjusted to match intensity and/or color of the light in the further region of interest. For example, light emitted by light source and sensor 202 may be adjusted to match (in intensity and/or color) light sensed by light source and sensor 206 in region of interest 208. Further, in some cases, light emitted by a light source and sensor may be adjusted to match light of two or more regions of interest e.g., an average of light sensed at two or more regions of interest. For example, light emitted by light source and sensor 202 may be adjusted to match (in intensity and/or color) an average of light sensed by light source and sensor 206 in region of interest 208 and light sensed by light source and sensor 210 in region of interest 212.

In operation 524, which is optional, it may be determined that a light source has failed (e.g., at least partially responsive to the sensed intensity of light in the region of interest). For example, processor 112 of FIG. 1 may determine that light source 104 of FIG. 1 has failed in response to light 116 sensed by sensor 108.

In operation 526, which is optional, an error message may be broadcast. The error message may be broadcast in response to a determination that the light source has failed, e.g., the determination of operation 524. For example, in response to a determination by processor 112 that light source 104 has failed, an error message may be broadcast via wireless-communication equipment 110.

Modifications, additions, or omissions may be made to method 500 without departing from the scope of the present disclosure. For example, the operations of method 500 may be implemented in differing order. Furthermore, the outlined operations and actions are only provided as examples, and some of the operations and actions may be optional, combined into fewer operations and actions, or expanded into additional operations and actions without detracting from the essence of the disclosed example.

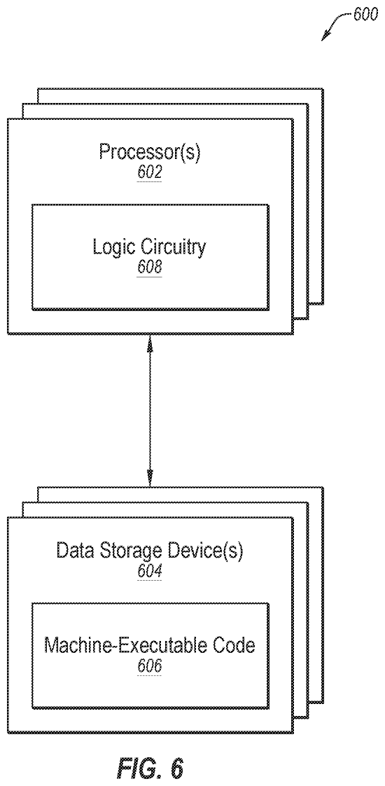

FIG. 6 is a block diagram of an example device 600 that, in various examples, may be used to implement various functions, operations, acts, processes, and/or methods disclosed herein. Device 600 includes one or more processors 602 (sometimes referred to herein as “processors 602”) operably coupled to one or more apparatuses such as data storage devices (sometimes referred to herein as “storage 604”), without limitation. Storage 604 includes machine-executable code 606 stored thereon (e.g., stored on a computer-readable memory) and processors 602 include logic circuitry 608. Machine-executable code 606 include information describing functional elements that may be implemented by (e.g., performed by) logic circuitry 608. Logic circuitry 608 is adapted to implement (e.g., perform) the functional elements described by machine-executable code 606. Device 600, when executing the functional elements described by machine-executable code 606, should be considered as special purpose hardware for carrying out the functional elements disclosed herein. In various examples, processors 602 may perform the functional elements described by machine-executable code 606 sequentially, concurrently (e.g., on one or more different hardware platforms), or in one or more parallel process streams.

When implemented by logic circuitry 608 of processors 602, machine-executable code 606 adapts processors 602 to perform operations of examples disclosed herein. For example, machine-executable code 606 may adapt processors 602 to perform at least a portion or a totality of method 400 of FIG. 4 or method 500 of FIG. 5. As another example, machine-executable code 606 may adapt processors 602 to perform at least a portion or a totality of the operations discussed for apparatus 102 of FIG. 1, and more specifically, processor 112 of FIG. 1. As another example, machine-executable code 606 may adapt processors 602 to perform at least a portion or totality of the operations discussed for light source and sensor 202, of FIG. 2, light source and sensor 206 of FIG. 2, light source and sensor 210 of FIG. 2, light source and sensor 214, of FIG. 2, light source 302 of FIG. 3 and sensor 316 of FIG. 3, light source 306 of FIG. 3 and sensor 318 of FIG. 3, light source 310 of FIG. 3 and sensor 320 of FIG. 3, light source 314 of FIG. 3 and sensor 318 of FIG. 3.

Processors 602 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes computing instructions (e.g., software code) related to examples of the present disclosure. It is noted that a general-purpose processor (may also be referred to herein as a host processor or simply a host) may be a microprocessor, but in the alternative, processors 602 may include any conventional processor, controller, microcontroller, or state machine. Processors 602 may also be implemented as a combination of computing devices, such as a combination of a DSP and a microprocessor, a plurality of microprocessors, one or more microprocessors in conjunction with a DSP core, or any other such configuration.

In various examples, storage 604 includes volatile data storage (e.g., random-access memory (RAM)), non-volatile data storage (e.g., Flash memory, a hard disc drive, a solid state drive, erasable programmable read-only memory (EPROM), without limitation). In various examples, processors 602 and storage 604 may be implemented into a single device (e.g., a semiconductor device product, a system on chip (SOC), without limitation). In various examples, processors 602 and storage 604 may be implemented into separate devices.

In various examples, machine-executable code 606 may include computer-readable instructions (e.g., software code, firmware code). By way of non-limiting example, the computer-readable instructions may be stored by storage 604, accessed directly by processors 602, and executed by processors 602 using at least logic circuitry 608. Also by way of non-limiting example, the computer-readable instructions may be stored on storage 604, transmitted to a memory device (not shown) for execution, and executed by processors 602 using at least logic circuitry 608. Accordingly, in various examples, logic circuitry 608 includes electrically configurable logic circuitry.

In various examples, machine-executable code 606 may describe hardware (e.g., circuitry) to be implemented in logic circuitry 608 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 608 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in various examples, machine-executable code 606 may include an HDL, an RTL, a GL description, a mask level description, other hardware description, or any combination thereof.

In examples where machine-executable code 606 includes a hardware description (at any level of abstraction), a system (not shown, but including storage 604) may implement the hardware description described by machine-executable code 606. By way of non-limiting example, processors 602 may include a programmable logic device (e.g., an FPGA or a PLC) and the logic circuitry 608 may be electrically controlled to implement circuitry corresponding to the hardware description into logic circuitry 608. Also by way of non-limiting example, logic circuitry 608 may include hard-wired logic manufactured by a manufacturing system (not shown, but including storage 604) according to the hardware description of machine-executable code 606.

Regardless of whether machine-executable code 606 includes computer-readable instructions or a hardware description, logic circuitry 608 is adapted to perform the functional elements described by machine-executable code 606 when implementing the functional elements of machine-executable code 606. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In various examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” without limitation).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, without limitation” or “one or more of A, B, and C, without limitation.” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the disclosure may include:

Example 1: An apparatus comprising: a light source to adjustably emit light toward a region of interest at least partially responsive to a control signal; a sensor to generate a signal indicative of an intensity of light sensed by the sensor in the region of interest; a wireless-communication equipment to broadcast a value that represents the intensity of light received by the sensor and to receive a broadcast of a further value that represents an intensity of light in a further region of interest; and a processor to adjust the control signal at least partially responsive to the further value.

Example 2: The apparatus according to Example 1, wherein the wireless-communication equipment is to receive two or more broadcasts of two or more respective further values including the received broadcast of the further value, wherein the processor is to select the further value of the received broadcast from among the two or more received broadcasts at least partially responsive to a respective received signal strength of each of the two or more received broadcasts, and wherein adjusting the control signal is at least partially responsive to the selected further value.

Example 3: The apparatus according to any of Examples 1 and 2, wherein the wireless-communication equipment is to receive two or more broadcasts of two or more respective further values including the received broadcast of the further value, wherein the processor is to select two or more further values of the two or more selected broadcasts, and wherein adjusting the control signal is at least partially responsive to an average of respective intensities of light represented by the selected two or more further values.

Example 4: The apparatus according to any of Examples 1 through 3, wherein the wireless-communication equipment is to measure a received signal strength of the received broadcast.

Example 5: The apparatus according to any of Examples 1 through 4, wherein the processor is to adjust the control signal independent of the signal indicative of the intensity of light in the region of interest.

Example 6: The apparatus according to any of Examples 1 through 5, wherein the light source comprises two or more individually-adjustable light-emitting diodes (LEDs).

Example 7: The apparatus according to any of Examples 1 through 6, wherein the received broadcast is further indicative of multiple intensities of light measured in the region of interest and wherein adjusting the control signal comprises adjusting the control signal to each of the two or more individually-adjustable LEDs such that the light source emits light responsive to multiple intensities of light measured in the further region of interest.

Example 8: The apparatus according to any of Examples 1 through 7, wherein the sensor is physically coupled to the light source.

Example 9: The apparatus according to any of Examples 1 through 8, wherein the sensor is separate from and communicatively coupled with the processor.

Example 10: The apparatus according to any of Examples 1 through 9, wherein the processor is to determine that the light source has failed at least partially responsive to the sensed intensity of light in the region of interest and to instruct the wireless-communication equipment to broadcast an error message at least partially responsive to determining that the light source has failed.

Example 11: The apparatus according to any of Examples 1 through 10, wherein adjusting the control signal comprises adjusting the control signal such that the light source emits light to match the intensity of light in the further region of interest.

Example 12: A method comprising: sensing an intensity of light in a region of interest; broadcasting a value indicative of the sensed intensity of light; receiving a broadcast of a further value that represents a sensed intensity of light in a further region of interest; and adjusting light emitted by a light source associated with the region of interest at least partially responsive to the further value that represents the intensity of light in the further region of interest.

Example 13: The method according to Example 12, comprising selecting the further value of the received broadcast from among two or more received broadcasts responsive to a respective received signal strength of each of the two or more received broadcasts.

Example 14: The method according to any of Examples 12 and 13, comprising: receiving two or more broadcasts of respective two or more further values that each represent an intensity of light in a respective further region of interest; and adjusting the light emitted by the light source at least partially responsive to an average of two or more respective intensities of light in the two or more further regions.

Example 15: The method according to any of Examples 12 through 14, wherein adjusting the light emitted by the light source at least partially responsive to the further value comprises adjusting the light emitted by the light source independent of the sensed intensity of light in the region of interest.

Example 16: The method according to any of Examples 12 through 15, comprising: receiving a broadcast of a subsequent further value that represents a subsequent intensity of light in the further region of interest; and readjusting the light emitted by the light source at least partially responsive to the subsequent further value.

Example 17: The method according to any of Examples 12 through 16, comprising determining that the light source has failed at least partially responsive to the sensed intensity of light in the region of interest and broadcasting an error message at least partially responsive to determining that the light source has failed.

Example 18: A system comprising: one or more sensors to broadcast one or more respective values that represent one or more respective intensities of light at one or more respective regions of interest; and one or more light sources each of the one or more light sources associated with a respective sensor of the one or more sensors, each of the one or more light sources to adjust respective light being emitted by the respective light source at least partially responsive to one or more received broadcasts including one or more respective values that represent one or more respective intensities of light in one or more respective further regions.

Example 19: The system according to Example 18, wherein each of the one or more light sources is to operate according to the same instructions to adjust the respective light being emitted by the respective light source.

Example 20: The system according to any of Examples 18 and 19, wherein each of the one or more light sources is to independently adjust the respective light being emitted thereby responsive to the one or more received broadcasts.

Example 21: The system according to any of Examples 18 through 20, wherein each of the one or more light sources is separate from and communicatively coupled with its associated sensor.

Example 22: The system according to any of Examples 18 through 21, wherein each of the one or more light sources is collocated with its associated sensor.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a light source to adjustably emit light toward a region of interest at least partially responsive to a control signal;
a sensor to generate a signal indicative of an intensity of light sensed by the sensor in the region of interest;
a wireless-communication equipment to broadcast a value that represents the intensity of light received by the sensor and to receive a broadcast of a further value that represents an intensity of light in a further region of interest; and
a processor to adjust the control signal at least partially responsive to the further value.

2. The apparatus of claim 1, wherein the wireless-communication equipment is to receive two or more broadcasts of two or more respective further values including the received broadcast of the further value, wherein the processor is to select the further value of the received broadcast from among the two or more received broadcasts at least partially responsive to a respective received signal strength of each of the two or more received broadcasts, and wherein adjusting the control signal is at least partially responsive to the selected further value.

3. The apparatus of claim 1, wherein the wireless-communication equipment is to receive two or more broadcasts of two or more respective further values including the received broadcast of the further value, wherein the processor is to select two or more further values of the two or more selected broadcasts, and wherein adjusting the control signal is at least partially responsive to an average of respective intensities of light represented by the selected two or more further values.

4. The apparatus of claim 1, wherein the wireless-communication equipment is to measure a received signal strength of the received broadcast.

5. The apparatus of claim 1, wherein the processor is to adjust the control signal independent of the signal indicative of the intensity of light in the region of interest.

6. The apparatus of claim 1, wherein the light source comprises two or more individually-adjustable light-emitting diodes (LEDs).

7. The apparatus of claim 6, wherein the received broadcast is further indicative of multiple intensities of light measured in the region of interest and wherein adjusting the control signal comprises adjusting the control signal to each of the two or more individually-adjustable LEDs such that the light source emits light responsive to multiple intensities of light measured in the further region of interest.

8. The apparatus of claim 1, wherein the sensor is physically coupled to the light source.

9. The apparatus of claim 1, wherein the sensor is separate from and communicatively coupled with the processor.

10. The apparatus of claim 1, wherein the processor is to determine that the light source has failed at least partially responsive to the sensed intensity of light in the region of interest and to instruct the wireless-communication equipment to broadcast an error message at least partially responsive to determining that the light source has failed.

11. The apparatus of claim 1, wherein adjusting the control signal comprises adjusting the control signal such that the light source emits light to match the intensity of light in the further region of interest.

12. A method comprising:
sensing an intensity of light in a region of interest;
broadcasting a value indicative of the sensed intensity of light;
receiving a broadcast of a further value that represents a sensed intensity of light in a further region of interest; and
adjusting light emitted by a light source associated with the region of interest at least partially responsive to the further value that represents the intensity of light in the further region of interest.

13. The method of claim 12, comprising selecting the further value of the received broadcast from among two or more received broadcasts responsive to a respective received signal strength of each of the two or more received broadcasts.

14. The method of claim 12, comprising:
receiving two or more broadcasts of respective two or more further values that each represent an intensity of light in a respective further region of interest; and
adjusting the light emitted by the light source at least partially responsive to an average of two or more respective intensities of light in the two or more further regions.

15. The method of claim 12, wherein adjusting the light emitted by the light source at least partially responsive to the further value comprises adjusting the light emitted by the light source independent of the sensed intensity of light in the region of interest.

16. The method of claim 12, comprising:
receiving a broadcast of a subsequent further value that represents a subsequent intensity of light in the further region of interest; and
readjusting the light emitted by the light source at least partially responsive to the subsequent further value.

17. The method of claim 12, comprising determining that the light source has failed at least partially responsive to the sensed intensity of light in the region of interest and broadcasting an error message at least partially responsive to determining that the light source has failed.

18. A system comprising:
one or more sensors to broadcast one or more respective values that represent one or more respective intensities of light at one or more respective regions of interest; and
one or more light sources each of the one or more light sources associated with a respective sensor of the one or more sensors, each of the one or more light sources to adjust respective light being emitted by the respective light source at least partially responsive to one or more received broadcasts including one or more respective values that represent one or more respective intensities of light in one or more respective further regions.

19. The system of claim 18, wherein each of the one or more light sources is to operate according to the same instructions to adjust the respective light being emitted by the respective light source.

20. The system of claim 18, wherein each of the one or more light sources is to independently adjust the respective light being emitted thereby responsive to the one or more received broadcasts.

21. The system of claim 18, wherein each of the one or more light sources is separate from and communicatively coupled with its associated sensor.

22. The system of claim 18, wherein each of the one or more light sources is collocated with its associated sensor.
